(19) United States
(12) Patent Application Publication
(10) Pub. No.: US 2017/0325017 A1
(43) Pub. Date: Nov. 9, 2017

(54) ELECTRICAL SPEAKER ASSEMBLY

(71) Applicant: WU-HSU LIN, Taichung City (TW)

(72) Inventor: WU-HSU LIN, Taichung City (TW)

(21) Appl. No.: 15/145,974

(22) Filed: May 4, 2016

(51) Int. Cl. H04R 1/28; H04R 1/24

(52) U.S. Cl. CPC H04R 1/2811; H04R 1/24; H04R 2201/029

(57) ABSTRACT

An electrical speaker assembly has a speaker element and two caps. The speaker element has two sides. The caps are attached respectively to the two sides of the speaker element, and each cap has a resonance space between the cap and a corresponding one of the sides of the speaker element, wherein one of the caps has a wire notch defined in the cap.

### BACKGROUND OF THE INVENTION

### 1. Field of the Invention

The present invention relates to a speaker assembly, and more particularly to an electrical speaker assembly that can increase the sound frequency and generate clear sounds.

### 2. Description of Related Art

With reference to FIG. 7, a conventional electrical speaker 90 comprises a copper plate 92 and a ceramic plate 91 attached to one side of the copper plate 92. When electric currents are led respectively into the copper plate 92 and the ceramic plate 91, the electrical speaker 90 can generate sounds because of different resonance frequencies of the materials of the plates 91,92.

However, the sound generated by the conventional electrical speaker 90 is in a low frequency, in a low voice, and is unclear, so the sound generated by the conventional electrical speaker 90 cannot be applied to seek objects or for identification and is not versatile in use.

To overcome the shortcomings, the present invention tends to provide an electrical speaker assembly to mitigate or obviate the aforementioned problems.

### SUMMARY OF THE INVENTION

The main objective of the invention is to provide an electrical speaker assembly that can increase the sound frequency and generate clear sounds. The electrical speaker assembly has a speaker element and two caps. The speaker element has two sides. The two caps are attached respectively to the two sides of the speaker element, and each cap has a resonance space between the cap and a corresponding one of the sides of the speaker element, wherein one of the caps has a wire notch defined in the cap.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an electrical speaker assembly in accordance with the present invention;

FIG. 2 is an exploded perspective view of the electrical speaker assembly in FIG. 1;

FIG. 3 is an enlarged side view in partial section of the electrical speaker assembly in FIG. 1;

FIG. 4 is an exploded perspective view of a second embodiment of an electrical speaker assembly in accordance with the present invention;

FIG. 5 is an enlarged side view in partial section of the electrical speaker assembly in FIG. 4;

FIG. 6 is an enlarged operational side view in partial section of the electrical speaker assembly in FIG. 1; and

FIG. 7 is a perspective view of a conventional electrical speaker.

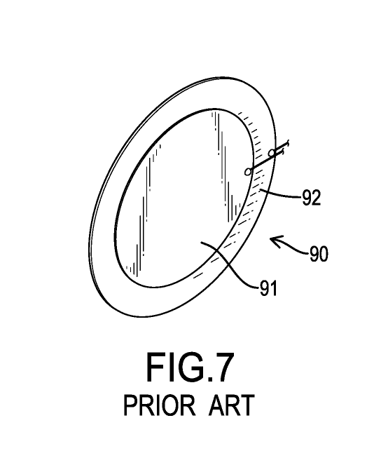

### DETAILED DESCRIPTION OF PREFERRED EMBODIMENT

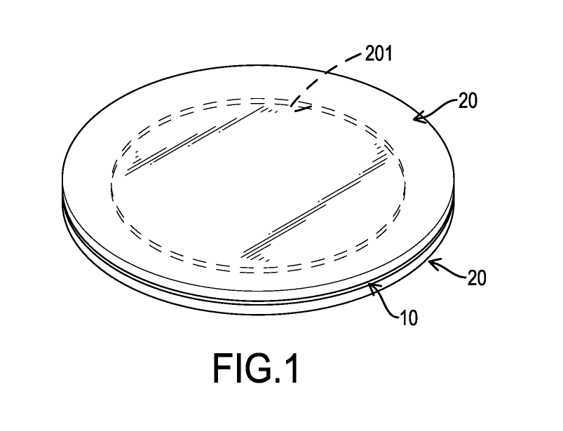

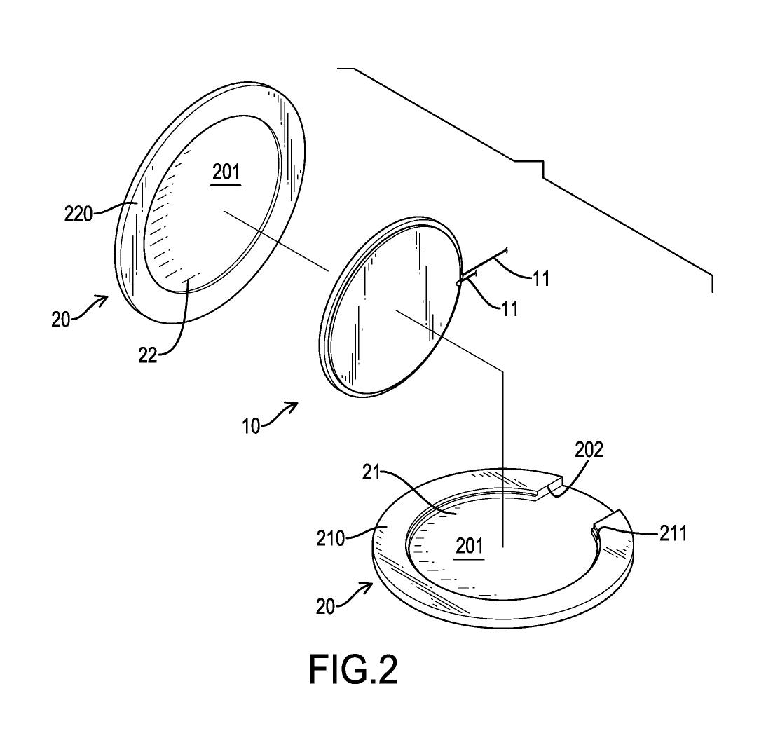

With reference to FIGS. 1 to 3, a first embodiment of an electrical speaker assembly in accordance with the present invention comprises a speaker element 10 and two caps 20. The speaker element 10 may be an electrical speaker that comprises a copper plate and a ceramic plate. When electric currents are led to the copper and ceramic plates, sound will be generated due to the different resonance frequencies of the plates. The two caps 20 are attached respectively to the two sides of the speaker element 10, and each cap 20 has a resonance space 201 between the cap 20 and a corresponding one of the sides of the speaker element 10. One of the caps 20 has a wire notch 202 defined in the cap 20.

Preferably, the two caps 20 include a first cap 21 and a second cap 22. The first cap 21 has a first abutting flange 210 and a holding recess 211. The first abutting flange 210 is annular, is formed on the first cap 21 at a side facing the speaker element 10, and has an inner surface. The holding recess 211 is defined in the inner surface of the first abutting flange 210 to hold the speaker element 10 inside the holding recess 211. The second cap 22 has a second abutting flange 220. The second abutting flange 220 is annular, is formed on the second cap 22 at a side facing the speaker element 10, and abuts the first abutting flange 210.

In addition, the wire notch 202 is defined through the first abutting flange 210 of the first cap 21. Alternatively, the wire notch 202 may be defined through the second abutting flange 220 of the second cap 22.

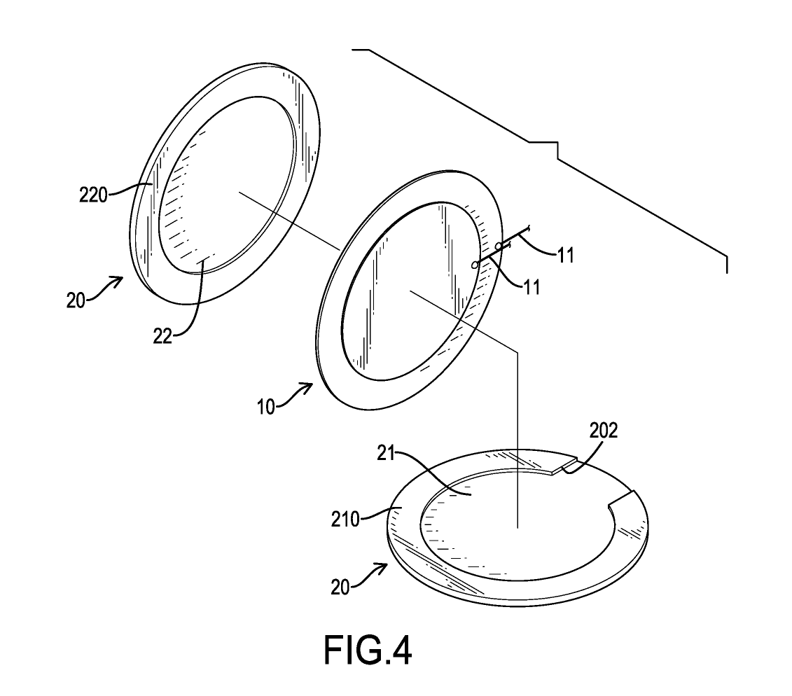

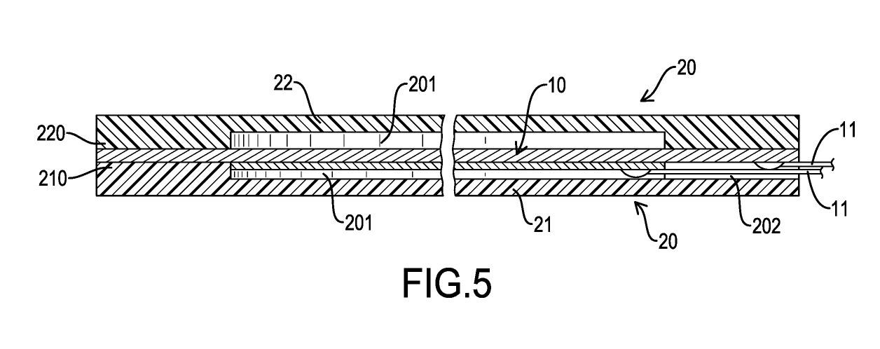

With reference to FIGS. 4 and 5, in the second embodiment of the electric speaker assembly in accordance with the present invention, the two caps 20 include a first cap 21 and a second cap 22. The first cap 21 has an annular first abutting flange 210 formed on the first cap 21 at a side facing the speaker element 10. The second cap 22 has an annular second abutting flange 220 formed on the second cap 20 at a side facing the speaker element 10. The first abutting flange 210 and the second abutting flange 220 abut respectively on two sides of a periphery of the speaker element 10.

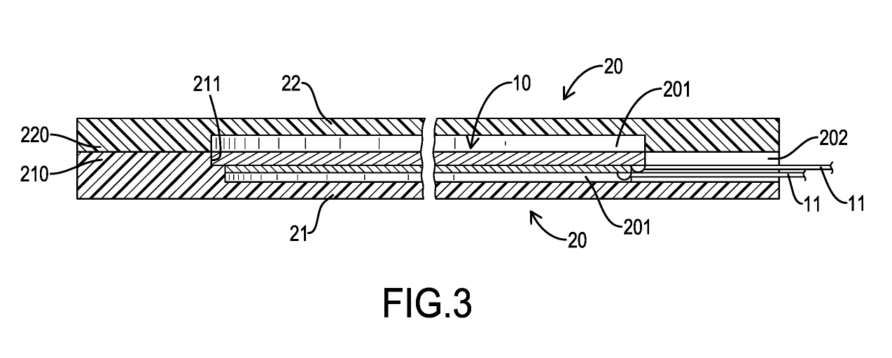

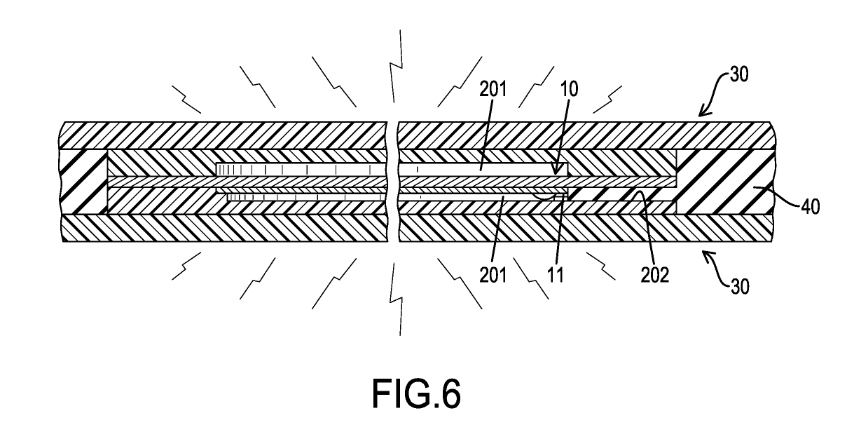

With reference to FIGS. 3 and 6, in use, the electrical speaker assembly in accordance with the present invention can be mounted in an object 30, such as a vehicle remote controller, an electrical switch or a proximity card. To assemble the electrical speaker assembly with the object 30, electrical wires 11 connected to the speaker element 10 are mounted through to extend out of the wire notch 202, and sealing material 40 is applied to seal the wire notch 202 to seal the resonance spaces 201.

With such an arrangement, two sealed resonance spaces 201 are defined between two sides of the speaker element 10. Therefore, when the speaker element 10 generates sound, the sound waves generated by the speaker element 10 will vibrate back and forth between the resonance spaces 201 to generate resonance. Accordingly, the sound frequency and the sound voice can be increased, the sound is clear, and the electrical speaker assembly can be applied to seek objects or for identification and is versatile in use.

In addition, with the caps 20 arranged on the two sides of the speaker element 10, the sealing material can be kept from attaching to the speaker element 10 during the sealing process. Therefore, the sound quality generated by the speaker element 10 will not be affected.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. (canceled)

2. An electrical speaker assembly comprising:
a speaker element having two sides; and
two caps attached respectively to the two sides of the speaker element, and each cap having a resonance space between the cap and a corresponding one of the sides of the speaker element, wherein one of the caps has a wire notch defined in the cap,
wherein
the two caps include a first cap and a second cap;
the first cap has an annular first abutting flange formed on the first cap at a side facing the speaker element;
the second cap has an annular second abutting flange formed on the second cap at a side facing the speaker element; and
the first abutting flange and the second abutting flange abut respectively on two sides of a periphery of the speaker element.

3. An electrical speaker assembly comprising,
a speaker element having two sides; and
two caps attached respectively to the two sides of the speaker element, and each cap having a resonance space between the cap and a corresponding one of the sides of the speaker element, wherein one of the caps has a wire notch defined in the cap,
wherein
the two caps include a first cap and a second cap;
the first cap has
an annular first abutting flange formed on the first cap at a side facing the speaker element and having an inner surface; and
a holding recess defined in the inner surface of the first abutting flange to hold the speaker element inside the holding recess; and
the second cap has
an annular second abutting flange formed on the second cap at a side facing the speaker element and abutting the first abutting flange.
